(19) United States
(12) Patent Application Publication
(10) Pub. No.: US 2003/0213869 A1
(43) Pub. Date: Nov. 20, 2003

(54) Translational propulsion system for a hybrid vehicle

(76) Inventors: Mark Winfield Scott, Bethany, CT (US); Vincent Francis Millea, Stratford, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/146,754

(22) Filed: May 16, 2002

(51) Int. Cl. B64C 15/00; B64C 29/00

(52) U.S. Cl. 244/12.2

(57) ABSTRACT

A translational propulsion system for a hybrid UAV includes a pusher prop mounted to the rear of the aircraft with its rotational axis oriented substantially horizontal. The pusher prop is mounted to a driveshaft assembly which transmits power from a coaxial transmission to drive the pusher prop. The driveshaft assembly includes a shaft which defines an axis of rotation. The shaft is mounted to the transmission through a crown spline assembly and is supported by a single bearing. The crown spline and the inherent slop in the bearing accommodates angular deflection and misalignment. The length of the shaft is selected such that the force on the crown spline is less than an allowable level.

This invention was made with government support under Contract No.: M67854-99-C-2081 awarded by the Department of the Army. The government therefore has certain rights in this invention.

### BACKGROUND OF THE INVENTION

The present invention relates to a hybrid aircraft, and more particularly, to a translational propulsion system of a hybrid unmanned aerial vehicle (UAV).

There is an increased emphasis on the use of UAVs for performing various activities in both civilian and military situations where the use of manned flight vehicles may not be appropriate. Such missions include surveillance, reconnaissance, target acquisition, target designation, data acquisition, communications relay, decoy, jamming, harassment, ordinance delivery, or supply.

A hybrid aircraft provides the hover and low-speed maneuverability of a helicopter with the high-speed forward flight and duration capabilities of a winged aircraft. Typically, hybrid aircraft include a helicopter control system which provides cyclic pitch, collective pitch and differential rotation to generate lift, pitch, roll, and roll control when operating in a hover/low-speed environment. Additionally, the hybrid aircraft includes a conventional fixed wing aircraft control system such as aileron, elevator, rudder and flaps to provide control when operating in a high-speed environment. Hybrid aircraft also typically include a separate translational propulsive system.

Powering the translational propulsive system requires a driveshaft assembly which transfers power from a transmission to a rear mounted pusher prop. The driveshaft assembly is typically supported by two bearings mounted in separate housings to react propeller forces. A quill shaft connects the prop shaft and the transmission via flexible couplings to accommodate flexing of the vehicle fuselage.

Although operationally quite effective, the conventional design requires a rather large number of components which increases the cost and weight of the tail mounted drive system. The weight of the tail mounted drive system may create difficulties for maintaining the center of gravity within acceptable limits. Moreover, the numerous components require a rather time consuming shimming process to avoid misalignment. Time consuming assembly complicates field maintainability requirements.

Accordingly, it is desirable to provide a driveshaft assembly for a hybrid aircraft which is lightweight and uncomplicated to assembly and maintain.

### SUMMARY OF THE INVENTION

A translational propulsion system for a hybrid UAV designed according to the present invention includes a pusher prop mounted to a rear portion of the vehicle. The pusher prop is mounted to the rear of the aircraft with its rotational axis oriented substantially horizontal. A pusher prop is mounted to a driveshaft assembly which transmits power from a coaxial transmission to drive the pusher prop. The driveshaft assembly includes a shaft which defines an axis of rotation. The shaft is mounted to the transmission through a crown spline assembly and is supported by a single bearing. The bearing is located adjacent the pusher prop.

The present invention utilizes the crown spline and the inherent slop in the bearing to accommodate angular deflection and misalignment. That is, a freedom of motion of the shaft axis of rotation is defined between the focal point of the crown spline assembly and the bearing. The length of the shaft is selected such that the force on the crown spline is less than the allowable level determined from analysis.

Accordingly, the present invention provide a driveshaft assembly for a hybrid aircraft which is lightweight and uncomplicated to assembly and maintain.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1A is a general perspective view of an exemplary hybrid aircraft having a flight control system according to the present invention;

FIG. 1B is a partially phantom view of the exemplary hybrid aircraft having a flight control system according to the present invention;

FIG. 2 is a general schematic view of translational propulsion system for the exemplary hybrid aircraft of FIGS. 1A and 1B;

FIG. 3A is a general front schematic view of a root bearing fit spline assembly;

FIG. 3B is a general sectional view of the crown spline assembly of FIG. 3A;

FIG. 4A is a general sectional view of a bearing assembly, and

FIG. 4B is a general sectional view of the bearing assembly of FIG. 4A in an articulated condition.

### DETAILED DESCRIPTION OF THE PREFERRED EMBODIMENT

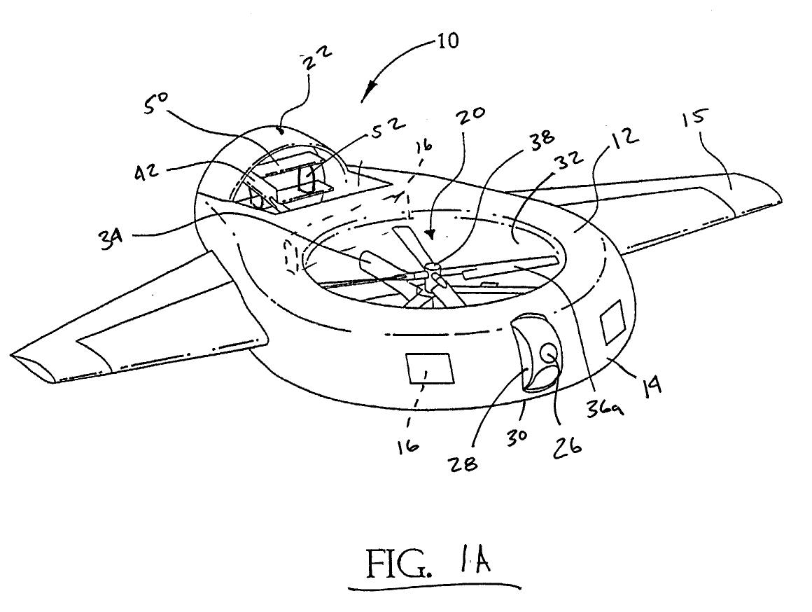

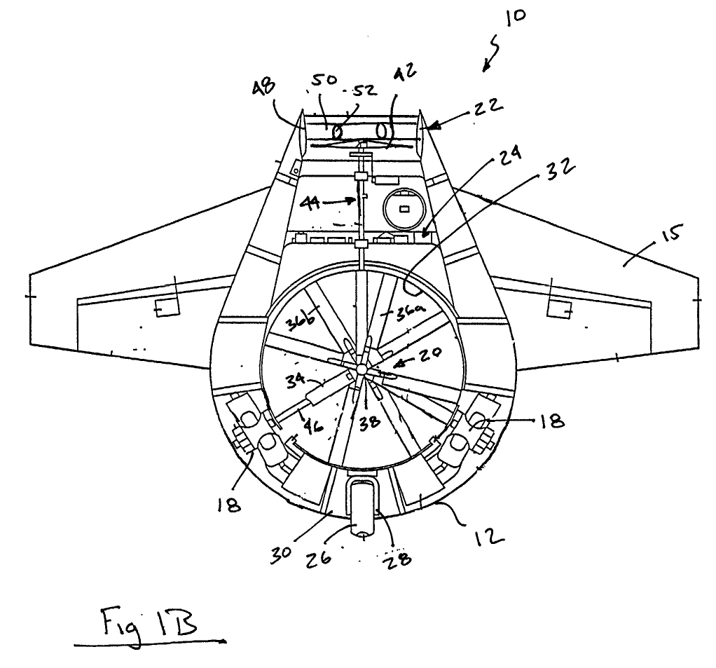

FIG. 1A illustrates a remotely controlled vehicle 10, such as the Unmanned Aerial Vehicle (UAV) developed by Sikorsky Aircraft Corporation. For further understanding of the UAV embodiment and associated components thereof, attention is directed to U.S. Pat. No. 6,170,778 entitled “Method of Reducing a Nose-Up Pitching Movement on a Ducted Unmanned Aerial Vehicle,” which is assigned to the assignee of the instant invention and which is hereby incorporated herein in its entirety.

The vehicle 10 includes a fuselage 12 with a toroidal portion 14 having a generally hemi-cylindrical aerodynamic profile. Wings 15 extend laterally outward from the aircraft fuselage 12 to provide high lifting forces and a nose-down pitching moment in forward translational flight. Those skilled in the art would readily appreciate the diverse wing arrangements that can be incorporated into a UAV according to the present invention.

The fuselage 12 includes a plurality of accessible internal bays 16 for housing and/or storing aircraft flight and mission components. Preferably, the bays 16 house one or more powerplant systems 18 (FIG. 1B) to drive a rotor system 20 and a translational propulsion system 22. The bays 16 also include a flight control system 24 (FIG. 1B) which generally includes flight computers, transmitters, receivers, navigation sensors and attitude sensors well known in the UAV field.

Mission related sensors 26, such as a camera system, forward looking infrared radar (FLIR) sensor, laser designator, thermal imager, communications, or the like are also preferably located in a trainable turret 28 in a forward area 30 of the vehicle 10. It should be understood that although a particular component arrangement is disclosed in the illustrated embodiment, other arrangements, replaceable mission packages, weapon systems and the like will benefit from the instant invention.

The rotor system 20 is mounted within a duct 32 that extends substantially vertically through the body 12. A plurality of struts 34 extend between the body and the rotor system 20 to rigidly attach the rotor system 20 in a fixed co-axial relation with respect to the duct 32. The support struts 34 provide structural rigidity to the aircraft duct 18 to prevent flight and ground loads from distorting the body 12. The support struts 34 are hollow structures which operate as conduits for interconnecting operating elements of the UAV 10.

The system 20 includes a pair of multi-bladed, counter-rotating rotors 36a, 36b, coaxially aligned with the duct 18, and a coaxial transmission therebetween (illustrated somewhat schematically at 38). Each counter-rotating rotor 36a, 36b (FIG. 1B) preferably includes a plurality of blade assemblies in which blade pitch changes, i.e., cyclic and/or collective pitch inputs, can be utilized to generate lift, pitch, yaw, and roll control of the aircraft 10.

The translational propulsion system 22 includes a pusher prop 42 mounted to a rear portion of the vehicle 10. The prop 42 is preferably mounted to the rear of the aircraft with its rotational axis oriented substantially horizontal. The pusher prop 42 is mounted to a driveshaft assembly 44 which transmits power from the coaxial transmission 38 to drive the pusher prop 42. Preferably, the driveshaft assembly 44 extends through a support strut 34. Separate driveshafts 46 extend through other support struts 34 to transfer power developed by each powerplant systems 18 to the coaxial transmission 38 which drives the rotor system 20 and the pusher prop 42 (FIG. 1B). Driveshafts 46 have less effect upon the vehicle 10 center of gravity than driveshaft assembly 44 as driveshafts 46 are shorter and are located in the forward area of the vehicle 10. Moreover, driveshafts 46 typically do not require a support structure other than support struts 34. Multiple powerplants 18 are interconnected through the coaxial transmission 38 such that a single powerplant 18 can drive all the propulsion systems in the event of a powerplant failure.

A prop shroud 48 is formed on the aft portion of the fuselage 12 and around the pusher prop 42. The cross-sectional shape of the shroud 48 is preferably configured as an airfoil to provide the shroud 48 with a lift component. Mounted on the shroud 48 aft of the pusher prop 42 are one or more horizontal and vertical control surfaces 50,52. Preferably, the control surfaces 50,52 are pivotally mounted to the shroud 48 to permit the exhausted air to be channeled in a controllable manner such that the horizontal control surfaces 50 function as elevators and the vertical control surfaces 52 function as rudders.

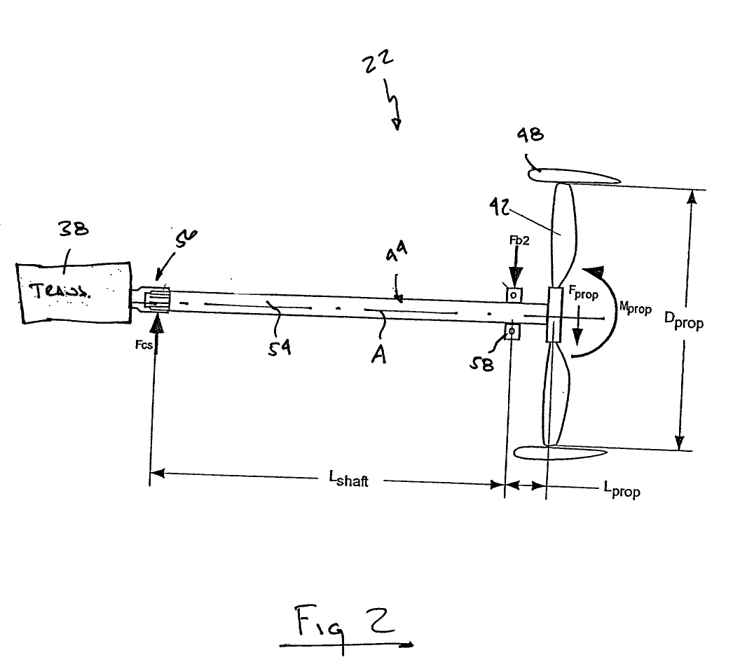

Referring to FIG. 2, the translational propulsion system 22 is schematically illustrated. The translational propulsion system 22 of the present invention accommodates propeller loads and fuselage deflection at lower weight, cost, complexity, and with higher efficiency than conventional designs. The pusher prop 42 is mounted to the driveshaft assembly 44 which transmits power from the coaxial transmission 38 (illustrated schematically) to drive the pusher prop 42. The driveshaft assembly 44 includes a shaft 54 which defines an axis of rotation A. The shaft 54 is mounted to a crown spline assembly 56 and supported by a single bearing 58. Bearing 58 is preferably located adjacent the pusher prop 42.

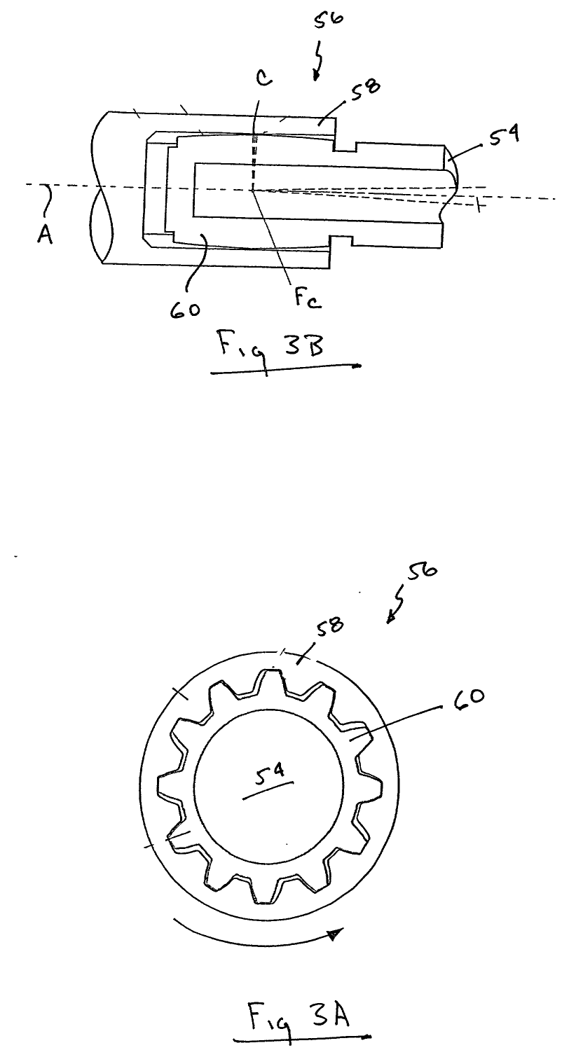

The crown spline assembly 56 includes a female outer crown spline 58 preferable driven by the transmission 38. The shaft 54 includes a male set of crown spline teeth 60 extending therefrom which are received within the female outer crown spline 58 (FIG. 3A).

Referring to FIG. 3B, conventional practice provides that drive train configurations place no side load on the spline. The present invention utilizes crown splines and bearings in a manner counter to conventional design practice. The top of each tooth of the male set of crown spline teeth 60 has a slight crown which allows angular displacement of axis A (FIG. 3B). Typically, +−1.5 degrees. This provides a shallow curvature on the top of the teeth such that a focal point Fc is defined about which axis A may angularly articulate. The gap between the spline teeth 60 and the inner diameter of the outer spline 58 is, for example only, less than 0.002 inches.

The present invention provides a small but definite contact area C between the inner spline teeth and the outer spline 58. This contact area supports a small but finite load. The load capability can be calculated using conventional bearing stress analysis similar to that used for conventional ball bearing analysis. The length of the shaft 54 is selected such that the side force on the crown spline (Fcs) is less than the allowable level determined from such an analysis.

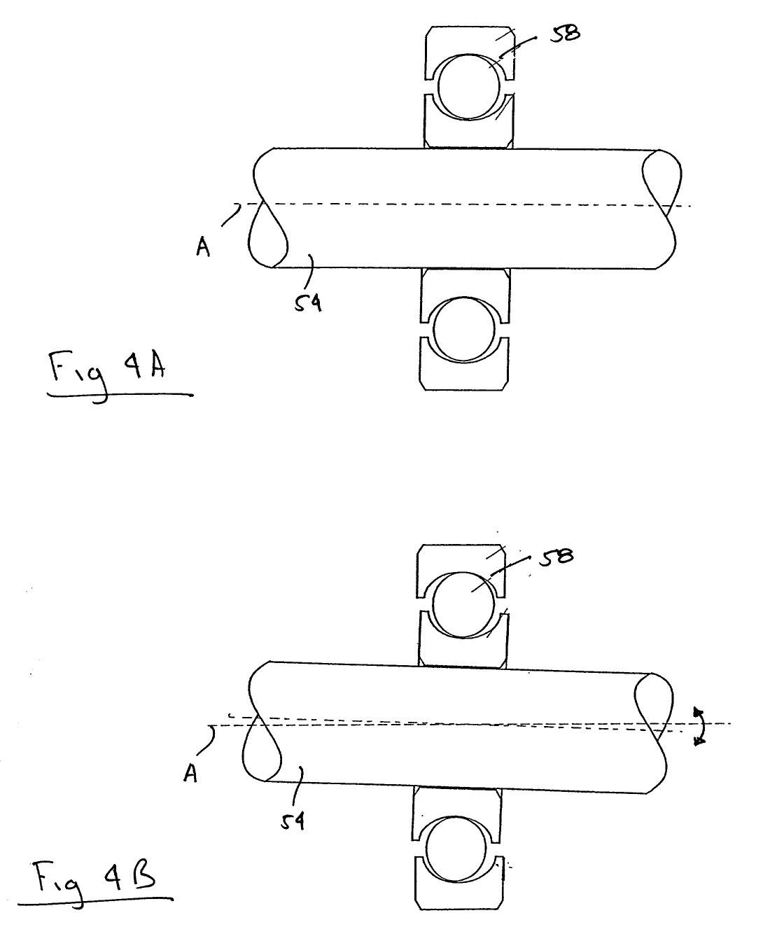

Referring to FIG. 4A, conventional bearing design practice dictates that bearings be aligned as perfectly perpendicular to the shaft as possible and the shaft remain as such, however, bearings do allow some angular freedom of motion before the balls ride outside of their races (FIG. 3B). That is, the race grooves are slightly larger than the ball diameter such that the inner race may angularly displace relative the outer race (FIG. 4B). Counter to conventional design practice, the present invention utilizes this displacement to accommodate angular deflection and misalignment of the shift. That is, a freedom of motion of axis A is defined between the focal point Fc and the bearing 58.

Given acceptable side load on the crown spline and the use of bearing slop to allow freedom of motion, the present invention requires selection of shaft lengths and the minimization of propeller forces and moments. A moment balance about bearing 58 is given in equation 1:

Fₚᵣₒₚ*Lₚᵣₒₚ+Mₚᵣₒₚ=F_{cs}*L_{Shaft} (1)

$${F}_{cs} = {F}_{prop} * \frac{{L}_{prop}}{{L}_{shaft}} + \frac{{M}_{prop}}{{L}_{shaft}} \qquad ( 2 )$$

Solving for the side force at the crown spline (F_{cs}), equation 2 shows that to reduce Fc the propeller force (Fₚᵣₒₚ), the length of the shaft aft of the bearing (Lₚᵣₒₚ), and propeller moment (Mₚᵣₒₚ) must be reduced (FIG. 2). Likewise, the distance between the bearing 58 and crown spline 56 (L_{shaft}) must be maximized.

Propeller aerodynamics are such that Fₚᵣₒₚ always acts in the same direction as F_{cs} on the other side of the bearing. Therefore, if forces are summed in the vertical direction F_{cs} is always reduced in proportion to Fₚᵣₒₚ. It should be understood that the formulation shown is for fundamental forces. It is provided for explanation purposes only and is not a complete analysis of the system.

Applicant has determined that that a (Lₚᵣₒₚ/L_{shaft}) ratio of 0.067 or lower is sufficient to keep F_{cs} low enough for a hardened steel crown spline to operate correctly. Applicant has also determined that a propeller shroud operates to reduce the propeller force and moment. It should be understood that ratios will differ for different propeller loads and crown spline materials.

In one configuration consistent with the UAV developed by Sikorsky Aircraft Corporation each powerplant drives driveshaft 46 (FIG. 1B) at approximately 7750 RPM and 27 horsepower. The freedom of motion required by shaft 54 is limited. For the Sikorsky configuration the maximum relative lateral or vertical displacement between the center of the propeller and the crown spline is about 0.188 inches. The relatively long distance (L_{shaft}) required (about 35 inches) to reduce the side force F_{cs} has the added benefit of reducing the angle at the spline assembly to less than 0.5 degrees. This is well within tolerable bearing 58 misalignment.

The present invention eliminates the weight, cost, and complexity of flex couplings and multiple bearings. The removal of the bearing also eliminates some frictional loss due to bearing drag.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A translational propulsion system for a hybrid vehicle comprising:
a spline assembly;
a shaft mounted to said spline assembly, said shaft defining an axis of rotation;
a pusher propeller mounted to said shaft; and
a bearing mounted about said shaft adjacent said pusher propeller such that a freedom of motion of said axis of rotation is defined between said spline assembly and said bearing.

2. The translational propulsion system as recited in claim 1, wherein said spline assembly comprises a crown spline assembly.

3. The translational propulsion system as recited in claim 1, further comprising a set of crown spline teeth extending from one end of said shaft, said set of crown spline teeth received within said spline assembly.

4. The translational propulsion system as recited in claim 3, wherein said a set of crown spline teeth comprise a male member and said spline assembly comprises a female member which receives said male member.

5. The translational propulsion system as recited in claim 3, wherein said set of crown spline teeth define a focal point for angular rotation of said freedom of motion.

6. The translational propulsion system as recited in claim 5, wherein said angular rotation of said freedom of motion is less than a maximum misalignment condition of said bearing.

7. The translational propulsion system as recited in claim 1, further comprising a pusher duct, said pusher propeller mounted within said pusher duct.

8. A hybrid unmanned aerial vehicle comprising:
a fueselage defining a duct;
a coaxial transmission driving a counter-rotating rotor system within said duct;
a female crown spline driven by said coaxial transmission;
a shaft defining an axis of rotation, said shaft comprising a set of crown spline teeth extending from one end of said shaft, said set of crown spline teeth received within said female crown spline;
a pusher propeller mounted to said shaft; and
a bearing mounted about said shaft adjacent said pusher propeller such that a freedom of motion of said axis of rotation is defined between said spline assembly and said bearing.

9. The hybrid unmanned aerial vehicle as recited in claim 8, wherein said set of crown spline teeth define a focal point for angular rotation of said freedom of motion.

10. The hybrid unmanned aerial vehicle as recited in claim 9, wherein said angular rotation of said freedom of motion is less than a maximum misalignment condition of said bearing.

11. The hybrid unmanned aerial vehicle as recited in claim 8, further comprising a pusher duct, said pusher propeller mounted within said pusher duct.
